(19) United States
(12) Patent Application Publication
(10) Pub. No.: US 2025/0106530 A1
(43) Pub. Date: Mar. 27, 2025

(54) A COMPACT OPTOELECTRONIC DEVICE FOR NONINVASIVE IMAGING

(71) Applicant: Brown University, Providence, RI (US)

(72) Inventors: Arto Nurmikko, Providence, RI (US); Ning Zhang, Providence, RI (US)

(21) Appl. No.: 18/856,549

(22) PCT Filed: Apr. 20, 2023
(86) PCT No.: PCT/US2023/066014

§ 371 Date: Oct. 11, 2024

Related U.S. Application Data
(60) Provisional application No. 63/332,902, filed on Apr. 20, 2022.

(51) Int. Cl. H04N 23/95; G06N 3/049; H04N 25/47

(52) U.S. Cl. CPC H04N 23/95; G06N 3/049; H04N 25/47

(57) ABSTRACT

A system includes a high density surface emitting laser array source, the high density surface emitting laser array source comprising a near infrared vertical cavity semiconductor laser (VCSEL) array that enables individual access to closely packed laser elements on a sub-microsecond timescale, a detector comprising a dynamic vision sensor having low latency, high dynamic range and ultralow power, and a chip scale neuromorphic computing platform configured to perform real-time target image reconstruction, the distinctly separate high density surface emitting laser array source, the detector and the chip scale neuromorphic computing platform integrated into a single functional whole.

### CROSS REFERENCE TO RELATED APPLICATIONS

This application claims benefit from U.S. Provisional Patent Application Ser. No. 63/332,902, filed Apr. 20, 2022, which is incorporated by reference in its entirety.

### STATEMENT REGARDING GOVERNMENT INTEREST

Not applicable.

### BACKGROUND OF THE INVENTION

The invention generally relates to imaging, and in particular to a compact optoelectronic device for noninvasive imaging.

In general, imaging and identifying targets of interest hidden in dense turbid media presents many obstacles. Targets could be subdermal sources in the body, vehicles in fog, objects in muddy waters, and so forth, obscured by the dominant light scattering from the surrounding medium. Much work has been directed at solving an inverse source problem, whether for noninvasive imaging of brain activity by near infrared spectroscopy or deploying time-gated detection to identify a vehicle moving in a fog. These approaches fall under the general heading of diffuse optical tomography (DOT) with state-of-the-art being severely challenged once the turbid media exceeds the equivalent of 60 photon mean free paths (attenuation>e⁻⁶).

### SUMMARY OF THE INVENTION

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

In an aspect, the invention features a system including a high density surface emitting laser array source, the high density surface emitting laser array source comprising a near infrared vertical cavity semiconductor laser (VCSEL) array that enables individual access to closely packed laser elements on a sub-microsecond timescale, a detector comprising a dynamic vision sensor having low latency, high dynamic range and ultralow power, and a chip scale neuromorphic computing platform configured to perform real-time target image reconstruction, the distinctly separate high density surface emitting laser array source, the detector and the chip scale neuromorphic computing platform integrated into a single functional whole.

In another aspect, the invention features a neuromorphic imaging pipeline architecture including a scattering medium with dynamic targets, laser driving circuits linked to a vertical-cavity surface-emitting laser (VCSEL) array, the VCSEL array providing photon injection into the scattering medium, a dynamic vision sensor (DVS) camera to provide photon detection from the scattering medium, the DVS camera sending spike trains to a neuromorphic chip for data driven neuromorphic execution, a deep spiking neural network (DSNN) for target reconstruction (image/video) on the neuromorphic chip, and a consistent signal pipeline with only asynchronous spiking signals generated at hardware level are the data flow.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

These and other aspects will now be described in detail with reference to the accompanying drawings, wherein:

FIG. 1 illustrates an exemplary optoelectronic device of the present invention.

FIG. 2 illustrates an exemplary approach to building a Physics-Informed Deep Spiking Neural Network (PI-DSNN) algorithm architecture based on Monte Carlo simulations.

FIG. 3 illustrates an exemplary data preparation/processing/computing pipeline of the present invention.

FIG. 4 shows a schematic of an exemplary wearable skin patch.

FIG. 5 illustrates an exemplary neuromorphic approach of the present invention for general purpose.

### DETAILED DESCRIPTION OF THE INVENTION

The subject innovation is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

The present invention is directed towards a compact optoelectronic device for noninvasive imaging of, for example, brain activity, which integrates two unique chip scale optoelectronic components on one device platform, i.e., a high-density surface emitting laser array source, matched with a dynamic vision camera chip as the detector. The compact optoelectronic device overcomes the perennial major limitations of deep non-invasive bioimaging in dense, turbid media. The compact optoelectronic device is capable of resolving metabolic dynamics of target vasculature in a specific functional region of the neocortex with 100 micrometer spatial resolution. Real-time image reconstruction is implemented by a chip scale neuromorphic computing platform, with a goal to achieve time resolution down to 100 millisecond scale of neuronal relevance.

A primary aspect of the present invention is an imaging system where three disparate and distinctly separate technologies are integrated into a single functional whole. Specifically, these are a laser array source, a so-called dynamic vision camera and a neuromorphic computing platform. Each of these three technology components is interconnected to the others and is functionally interdependent of the other two.

An example of the interdependence and necessity for the three elements of the invention to be holistically co-designed is the following. The design and implementation of the VCSEL array is dependent of the integration of this array to the DVS camera. The DVS camera, in turn, must be designed and operated so that in can be synchronized, pixel by pixel with the VCSEL array, laser element by laser element. The DVS camera also needs to be electronically programmed to send the event-detected, spike train data as input to the neuromorphic processor for image reconstructions. For developing the algorithms for the neuromorphic processor the design of the VCSEL array is required in order to design a physics-informed computational basis.

Optoelectronic devices represent the forefront in technology. The photonic source is a unique near infrared (λ˜850 nm) vertical cavity semiconductor laser array (VCSEL array) which enables individual electronic access to the approximately 100 closely packed laser elements on a sub-microsecond timescale. The two-dimensional gallium arsenide quantum well array occupies a 1×1 mm² chip area with individual laser aperture size 100 μm and inter-element pitch of 100 μm—the VCSEL array providing an ultrahigh-density multichannel optical source capable of fast, dynamically patterned coherent illumination.

The device of the present invention includes a dynamic vision (event-sensing) camera chip (DVS) to collect the backscattered infrared light from the turbid media (e.g., scalp, skull, dura, and the cortex). The camera chip and its integrated electronics record only the dynamical events of interest as “spikes,” thereby subtracting the uninformative static or quasi-static background which often confounds standard detection approaches. In addition, the camera electronics are temporally synchronized with pulsed emission from each VCSEL laser element. This allows the “spiking” data be acquired as a matrix representation S_{i,j}·D_{k,1}, where each source/detector pixel pair represents contribution from a separate photon source channel to the full image within the instrument's field of view.

The recorded data from the large channel count source-detector device is decoded by applying neuromorphic computing for target image reconstruction. In particular, the device deploys neuromorphic hardware (e.g., Intel's Loihi2 research chip) and uses purpose-specific algorithms for the neuromorphic processor chip running a model-based deep spiking neural network (DSNN) learning algorithm. Loihi2 is a neuromorphic research test chip designed by Intel Labs that uses an asynchronous spiking neural network (SNN) to implement adaptive self-modifying event-driven fine-grained parallel computations used to implement learning and inference with high efficiency.

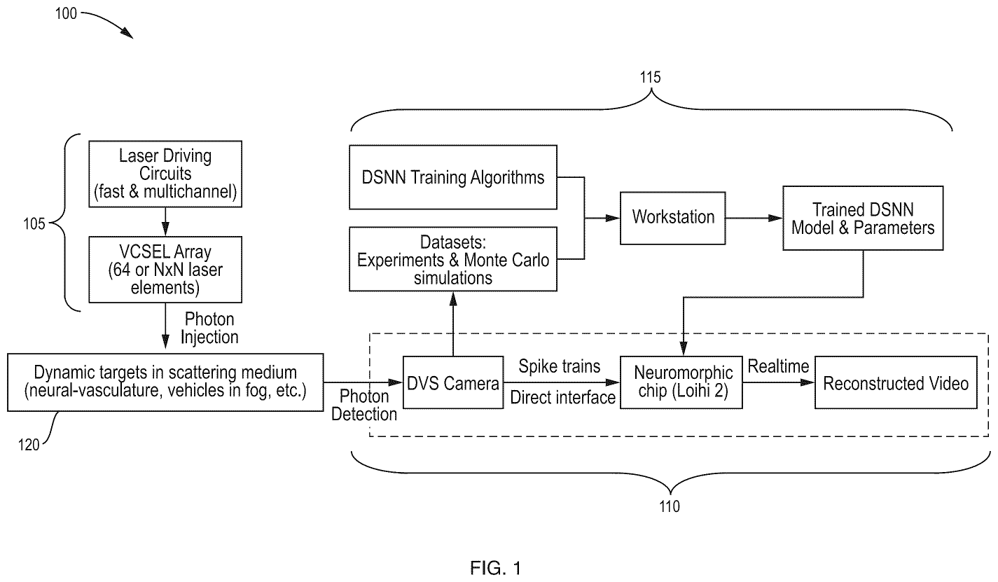

As shown in FIG. 1, an exemplary optoelectronic device for noninvasive imaging 100 includes a high density surface emitting laser array source 105. This the high density surface emitting laser array source 105 includes a near infrared vertical cavity semiconductor laser (VCSEL) array that enables individual access to closely packed laser elements on a sub-microsecond timescale.

The optoelectronic device 100 includes a detector 110 that includes a dynamic vision camera chip having low latency, high dynamic range and ultralow power. The dynamic vision camera (chip) detects time-varying changes in optical constants (dynamic pulsations in blood flow oxy/deoxy hemoglobin; possible microemboli; moving targets behind fog) and send out asynchronous spike trains.

The optoelectronic device 100 includes a chip scale neuromorphic computing platform 115 configured to perform real-time target image reconstruction.

The optoelectronic device 100 enables noninvasive imaging of, for example, brain dynamics 120, or other physiological circuits (e.g., cardiac) though native metabolic biomarkers. The optoelectronic device 100 provides dynamic image reconstruction, replacing conventional image processing models/algorithms (such as DOT method) by neuromorphic event sensors (DVS) and SNN-based reconstruction.

The dynamic vision camera chip detects time-varying changes in optical constants, collects backscattered infrared light from a turbid media and records dynamic events of interest as spike data. As described above, the dynamic vision camera chip may be temporally synchronized with pulsed emission from each VCSEL array, enabling the spike data to be acquired as a matrix representation S_{i,j}×D_{k,1}, where each source/detector pixel pair represents contribution from a separate photon source channel to a full image within the dynamic vision camera chip's field of view.

The chip scale neuromorphic computing platform 115 includes an asynchronous spiking neural network (SNN) for adaptive self-modifying event-driven fine-grained parallel computations used to implement learning and inference with high efficiency.

In the configuration discussed above, the optoelectronic device 100 provides a consistent pipeline, i.e., spiking signals (generated at hardware level) are the only data flow.

In summary, the present invention is a dynamical imaging system capable of recognizing and describing detail shapes and kinematics of moving objects in dense turbid media, or stationary objects in such media whose physical properties are internally time varying. The system may use light or other electromagnetic or sound waves for detecting and imaging an object of interest which is obscured by the scattering turbid media. Applications of interest include resolving detailed features and trajectory of a moving vehicle in fog, tracking submerged objects in murky waters or assess the performance of an active organ in the body.

As used herein, the phrase “dynamical imaging” means that the system specifically detects any and all time-varying aspects of the object to be recognized for reconstructing its detailed image.

As used herein, the phrase “turbid media” is equivalent to a dense fog, if light is used as the modularity in the system.

As used herein, the phrase “detecting and imaging” is synonymous to an ability to reconstruct details of the object by the system as if the turbid media (“fog”) no longer obscured the object.

The system of the present invention is composed of a subsystem that combines a source (or arrays of sources) of energy (light, electromagnetic waves, sound) with a receiver (or arrays of receivers) using the same form of energy for detection with a subsystem composed of integrated signal processing and computing. The signal processing and computing subsystem captures the data from the source-detector subsystem and applies neuromorphic image reconstruction which is used to generate an image of the object of interest.

The source-receiver subsystem is a device where both the source and the receiver are composed of multiple elements. Energy transmitted from particular source element (or elements) through the turbid medium is detected by a particular receiver element (or elements) at a specific time. All the source-detector pair elements are precisely and mutually synchronized as the system receives signals from the environment of interest.

In principle, the system can scan across the entire accessible space though it would shorten the imaging time if there is some foreknowledge of its approximate location as per available auxiliary information.

The receiver is an electronic device including arrays of elements. Each element (“pixel”) asynchronously converts the detected time-varying input introduced by the dynamics of the object of interest to current/voltage impulses (spikes). A spike can only be generated if the detected difference between the current measurement and the prior measurement, is larger than a preset threshold. The rate of repetition is proportional to the rate of change in the received intensity of light, sound, or other electromagnetic wave. The series of impulses are referred to as a “spike train.”

Whereas the receiver can be viewed as established technology for a multipixel camera which detects dynamical changes in light intensity, i.e., “Dynamic Vision Sensor (DVS) or Event Camera,” the present invention uses the sensors, such as DVS, for the first time, to image dynamic targets inside turbid media. The present invention leverages the uniqueness of DVS to only detect changes caused when the object is a dynamic (i.e., moving or changing shape/color). The DVS has natural ability to filter out the unwanted static signals and suppress the noise. It is asynchronous, very low latency (˜1 us), high dynamic range (120 dB) and features ultra-low power consumption.

The present invention also combines the DVS type receiver with a multi-element source array, and then uses the subsequent neuromorphic algorithms (physics-informed deep-learning spiking neural network) on a real neuromorphic computation chip (hardware) for image reconstruction of an object which is obscured by a surrounding turbid medium (for applications like biomedical imaging). The full pipeline only detects perturbation and ignores the useless background noise. It only uses spikes as signal which makes the system information-sparse and energy-efficient. It is asynchronous and low-latency which means it can output the reconstructed information in real real-time. From the front-end (spiking sensor) to the computational algorithms and hardware (neuromorphic chip), they are all ultra-low power consumption, which makes this system of the present invention very fit to be wearable, for example.

The information from all the source-receiver element pairs, converted to electronic spike train signals, provide the data driven input to the neuromorphic computing phase in the overall process to create a specific new class of algorithms for the problem of detection and imaging objects in turbid media.

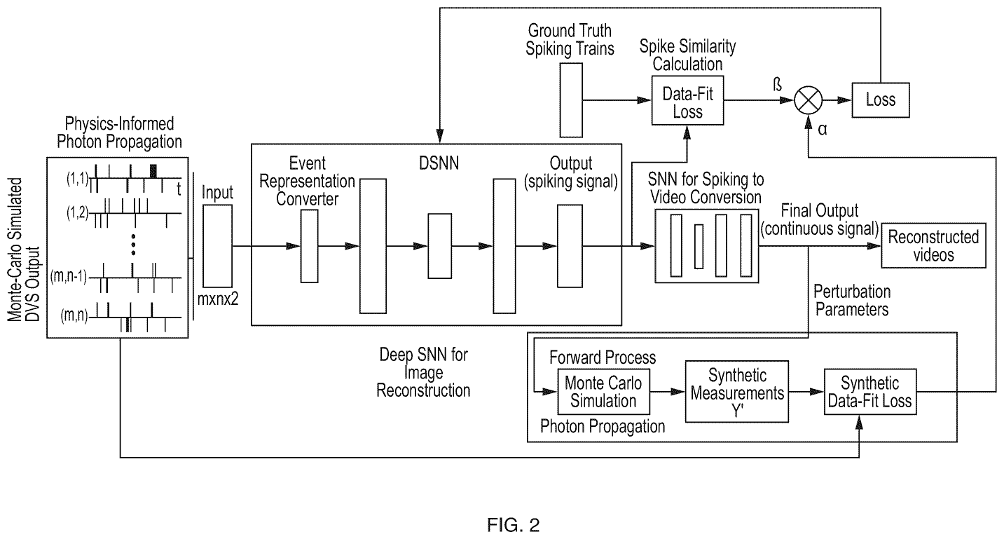

As shown in FIG. 2, the neuromorphic approach 200 represents a new type of data-driven deep-leaning algorithm (DSNN) which has several internal components. These components include a physics-informed propagation model for the source energy to propagate from the source to receiver as a means to characterize the turbid medium, the DSNN engine including spike-train encoding layer, the intermediate computing layer in latent representation, the spike-train similarity error-minimizing layer where the available training data is used to complete the image reconstruction of the object of interest as a last step.

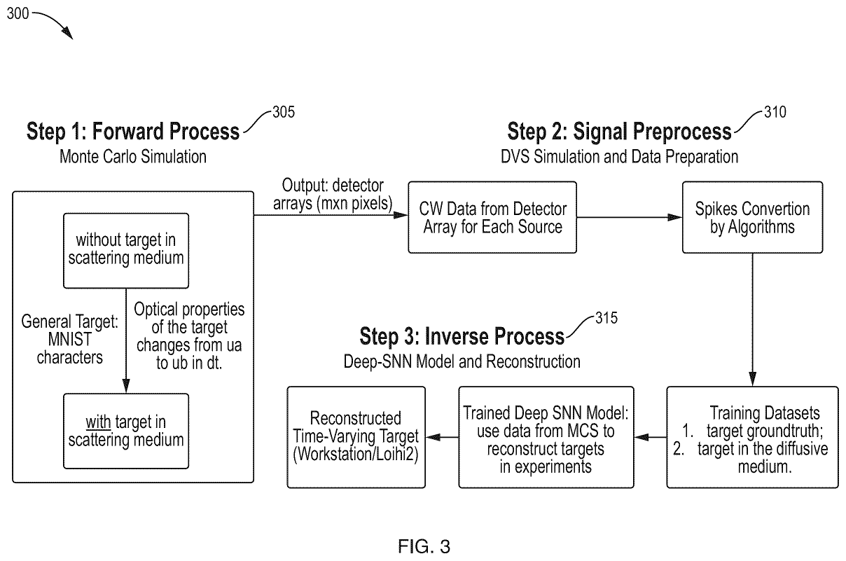

In FIG. 3, an exemplary data processing/computing pipeline 300 illustrates how we prepared the physics informed datasets and how we used this to train the DSNN. The data processing/computing pipeline 300 includes a forward process 305, a signal pre-process 310 and an inverse process 315. The forward process 305 includes a Monte Carlo simulation. The signal pre-process 310 includes a DVS simulation and data preparation. The inverse process 315 includes a deep-SNN model and reconstruction.

The forward process 305 shows the photon propagation from the VCSEL microlasers through scattering inside tissue to the DVS camera. In principle, either simulations and experiments can accomplish the forward process, but as it is highly impractical to collect large data sets through experiments, we use simulated data, well-grounded in the physics of photon scattering, to train the DSNN. We use the ‘Monte Carlo Extreme’ toolkit (MCX) for speed and accuracy to build our forward model. A target such as a tumor or vessel is embedded in the scattering medium with its optical properties varying in time intervals At depending of the physiological dynamics. The optical ‘perturbation’ arises from variation in index of refraction and the absorption coefficient and is detected by the DVS detector array (up to million pixels). A large number of datasets (>60000) is generated by MCS for training.

In signal pre-processing 310, spiking encoding algorithms such as step-forward (SF) encoding and temporal-contrast (TC) encoding are used to encode the continuous signals into spiking signals. The obtained datasets include targets embedded in transparent medium (ground truth) and in diffusive medium (training/testing). Artificial noise and channel reduction can be added.

In the inverse process 315, the DSNN model uses the simulated datasets to train and test itself. The output of the network is the reconstructed target. A sufficiently well-trained DSNN (as a nonlinear method) can be expected to solve the inverse problem accurately and efficiently. The DSNN outputs will be updated in real time according to the latest arrival spike trains at its inputs. The final output will be a real time reconstructed video-type image of the time-varying target.

It should be noted that the datasets preparation can include methods other than Monte Carlo simulation, for example, analytical methods based on diffusion equation and experiment datasets.

In the configuration discussed above, the optoelectronic device 100 provides a consistent pipeline, i.e., spiking signals (generated at hardware level) are the only data flow. This neuromorphic imaging pipeline design includes the VCSEL array and drivers for raster scanning or patterned illumination (e.g., the head in brain imaging), the DVS camera that sends spike trains to the Intel Loihi2 neuromorphic chip for data driven neuromorphic execution, and the DSNN design and methods of generating training data sets (green boxes). The spike layer error reassignment (‘SLAYER’) framework is used in designing a backpropagation-based DSNN. In turn the DSNN is trained at a cloud-based computing cluster. At the end, the optimal DSNN model is selected and deployed, for example, on a wearable Loihi2 platform.

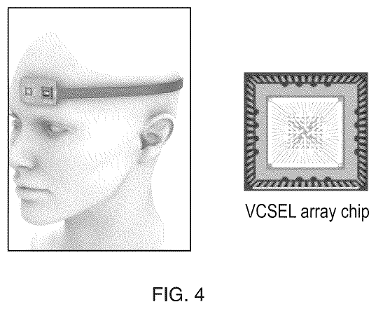

FIG. 4 shows a schematic of a wearable skin patch capable of high-resolution tomography and brain recording for a mobile subject. For illustrative purpose only, the main photonic component chips are facing outward (surface emitting laser array and dynamic vision camera chip, respectively.)

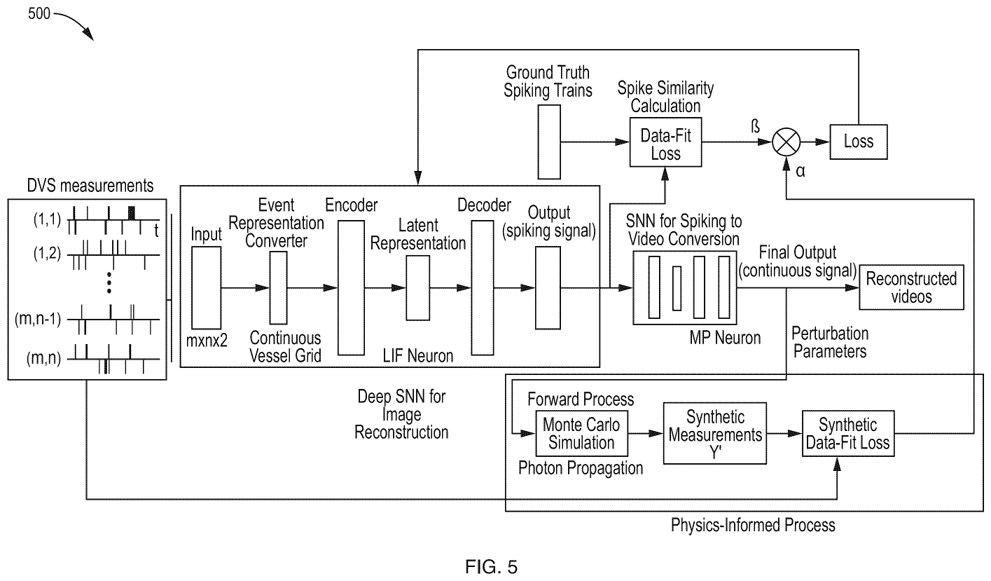

FIG. 5 describes an approach 500 to building a Physics-Informed Deep Spiking Neural Network (PI-DSNN) algorithm architecture, beginning from DVS measurement block with inputs are from the camera. Each pixel forms an individual input channel. The spiking signal from a DVS (or after encoding the simulated data) is a function of position and time coordinates, f [x, y, t, p], where p is the spike polarity. In the DSNN block the mxn spike trains are converted into continuous voxel grids using an event representation converter, to train and test our model. The voxel grids are passed into Ne encoder layers, Ni latent representations, and Na decoder layers for starting the reconstruction process. (All spikes modeled as leaky integrate-and-fire (LIF) neurons). The DSNN block outputs spike trains which are (1) compared with ground truth spike trains directly to calculate the spike similarity as the data-fit loss; (2) fed into the next stage SNN block for actual image/video reconstruction as the final output. The reconstruction layer of the SNN embeds membrane potential (MP) neurons who's role is to convert spikes into continuous signals. In the simplest training scenario, the data-fit loss can be fed into the DSNN directly to train the network. However, bioimaging targets are likely to be complex in geometry and the background tissue heterogeneous. Therefore, a physics-informed layer is added to provide physical a priori knowledge to the DSNN to guide the algorithm toward solutions which are physically realistic. Here the predicted parameters (extracted from the reconstructed videos) are fed into a forward process i.e., the Monte Carlo simulation (MCS) that describes photon transport in scattering media. Including the iterative ‘perturbations’ from the previous looping through the DSNN, the MCS simulates and updates the synthetic measurements (from simulated VCSEL/DVS sensor array). Then the computationally efficient, time saving synthetic measurements can be (less frequently) compared with actual DVS measurements to extract another loss parameter: synthetic data-fit loss. The ‘faster tempo’ data-fit loss and ‘slower tempo’ synthetic data-fit loss is then weighted and combined as a final loss to update the DSNN.

Although only a few embodiments have been disclosed in detail above, other modifications are possible. All such modifications are intended to be encompassed within the following claims.

What is claimed is:

1. A system comprising:
a high density surface emitting laser array source, the high density surface emitting laser array source comprising a near infrared vertical cavity semiconductor laser (VCSEL) array that enables individual access to closely packed laser elements on a sub-microsecond timescale;
a detector comprising a dynamic vision sensor having low latency, high dynamic range and ultralow power; and
a chip scale neuromorphic computing platform configured to perform real-time target image reconstruction, the distinctly separate high density surface emitting laser array source, the detector and the chip scale neuromorphic computing platform integrated into a single functional whole.

2. The system of claim 1 wherein the dynamic vision camera chip detects time-varying changes in optical constants.

3. The system of claim 2 wherein the dynamic vision camera chip collects backscattered infrared light from a turbid media and records dynamic events of interest as spike data.

4. The system of claim 3 wherein the dynamic vision camera chip is temporally synchronized with pulsed emission from each VCSEL array, enabling the spike data be acquired as a matrix representation S_{i,j}×D_{k,1}, where each source/detector pixel pair represents contribution from a separate photon source channel to a full image within the dynamic vision camera chip's field of view.

5. The system of claim 4 wherein the chip scale neuromorphic computing platform comprises an asynchronous spiking neural network (SNN) for adaptive self-modifying event-driven fine-grained parallel computations used to implement learning and inference with high efficiency.

6. A neuromorphic imaging pipeline architecture comprising:
a scattering medium with dynamic targets;
laser driving circuits linked to a vertical-cavity surface-emitting laser (VCSEL) array, the VCSEL array providing photon injection into the scattering medium;
a dynamic vision sensor (DVS) camera to provide photon detection from the scattering medium, the DVS camera sending spike trains to a neuromorphic chip for data driven neuromorphic execution;
a deep spiking neural network (DSNN) for target reconstruction (image/video) on the neuromorphic chip; and
a consistent signal pipeline with only asynchronous spiking signals generated at hardware level are the data flow.
